(19) United States
(12) Patent Application Publication
(10) Pub. No.: US 2018/0183805 A1
(43) Pub. Date: Jun. 28, 2018

(54) SYSTEM AND METHOD OF AUTHORIZATION OF SIMPLE, SEQUENTIAL AND PARALLEL REQUESTS WITH MEANS OF AUTHORIZATION THROUGH PREVIOUSLY DEFINED PARAMETERS

(71) Applicant: Ivan Mauricio GONZALEZ CORONA, Leduc (CA)

(72) Inventor: Ivan Mauricio GONZALEZ CORONA, Leduc (CA)

(21) Appl. No.: 15/537,806

(22) PCT Filed: Dec. 15, 2015
(86) PCT No.: PCT/MX2015/000193

§ 371 Date: Dec. 14, 2017

(30) Foreign Application Priority Data
Dec. 18, 2014 (MX) MX/A/2014/015834

(51) Int. Cl. H04L 29/06; G06Q 20/40; G06K 7/14

(52) U.S. Cl. CPC H04L 63/104; G06K 7/1417; G06Q 20/401; H04L 63/101

(57) ABSTRACT

This invention provides a system and a method for the authorization of simple, sequential and parallel requests, such transactions are preferably of the financial type, the system includes the authorization of transactions through means of authorization, and such means can be quick response codes through mobile devices, each code includes at least three keys which encrypt the information of each financial transaction, which increases security; similarly, this invention includes a modality for the selection of parameters previously established by the user (rules) who conducts the authorization and a secure access mode, which is activated when the user is coerced to conduct the authorization.

### PURPOSE OF THE INVENTION

The purpose of this invention is to provide a system and a method for the authorization of simple, sequential and parallel requests, such transactions are preferably of the financial type, the system includes the authorization of transactions through means of authorization, which can be quick response (QR) codes through mobile devices, each code includes at least three keys which encrypt the information of each financial transaction, which increases security; similarly, this invention includes a modality for the selection of parameters previously established by the user (rules) who conducts the authorization and a secure access mode, which is activated when the user is coerced to conduct the authorization.

### BACKGROUND OF THE INVENTION

Immersed in the so-called Information Society, our way of relating is increasingly linked to computer networks and particularly to Internet. Technology based in the use of computers is transforming our way of accessing, storing and distributing information. Trade is one of the fields that has undergone a significant change due to the introduction of these technologies is the commerce.

The performance of financial transactions through electronic information on telecommunication lines, is commonly known as Electronic Commerce. The use of secure and efficient payment systems is a key point for the success of electronic commerce. The need for security in this type of transactions is increased when considering that most of such exchanges are made through the Internet (whether through the use of personal computers or mobile phones).

The basic security services required for trusting the economic transactions on this type of electronic means are:
Privacy: protection against eavesdropping. This service is especially important for transactions in which credit card numbers are sent through the web.
User Identification: protection against identity theft. Any exchange or economic transaction shall ensure that the participants of such transaction known who they are dealing with.
Integrity: protection against the substitution of the original message. It shall be ensured that the copy of the message received is the same than the one sent.
Repudiation: protection against future denials of service provided or received.

Due to the above, several technologies have been developed in recent years with the purpose of providing security in the authorization of requests, such as the ones described below:

The American-origin patent US2014101741 provides authentication systems for the use of mobile devices, where the users can register a mobile device and the password with an authentication system; in order to have access to a secure system, users can send a request with a telephone number registered through SMS, Internet or phone, the authentication server system can send a signal and the position of the password through SMS; users can introduce the authentication code which is made up by the signal and password in the secure system, which compares the authentication code with the stored authentication code to enable access to the secure system.

The document US2014089178 details a system of mobile financial transactions and a method to be used with a mobile payment and a secure financial service platform; with the method and system described, users can conduct mobile financial transactions with a handheld mobile device. First, the billing information is acquired through the Internet and/or through an image capture, then an integrated micro SD flash memory card with a security chip contains a personal financial information located close to the communication technology used to communicate with the payment devices. The payment information is transferred to a payment gateway to conclude a financial transaction. In addition, it includes a value-added service platform which provides a secure follow-up of the financial services.

Another similar technology is the one described in the document US2012171997, which is a security system that includes a software application which is executed in the mobile phone of a user, and allows to visualize a separately generated key that the user can voluntarily scan with the phone's camera. The visual key includes digital data encoded in a series of color cells arranged in a Colorgram (heatgram). These original data are treated as a security factor, and is concatenated with other security factors so the users are able to authenticate themselves in web sites, Internet services, or in mobile device applications; when the users authenticate themselves in a server, the server returns, in a brief period, a password or unique account numbers that are used for a single time to be used as a secure access of the financial transactions in other systems.

The international application number WO2004114231 provides techniques for the verification of an electronic financial transaction, which includes the generation of a user interface including a security code, the user interface associates different portions of the code with different parts of a user input device, and at least one part of the code is associated with a part of the user input device which has visual cues different from the visual representation of the part of the code; for the verification of an electronic financial transaction, it includes the detection of the activation of the user input device by generating a code, and determines if the generated code corresponds to the security code.

The document WO9829983 refers to the generation of an encrypted key for a message to be transmitted through a communications network, where there is not a real-time link between the encryption and decryption devices; an application of this invention consists in the financial transactions between a client, supplier and financial institution; it is derived from the recognition that if the transactions are not produced in real time or in a total security environment in the transmission, the transaction shall be considered as unidirectional by the client (or his/her equipment) to the issuer, therefore, a unique key is generated for each transaction, preferably without reference to the external devices, however, the issue institution will be aware of the encryption key for each device, and when it is combined with additional data (in the illustrative case of a random input number to a rotation or other reorder algorithm), the issuer can recover the correct key and decrypt this protected part of the transaction identification block; in addition two unidirectional operations can form a bidirectional transaction session.

The Mexican patent MX 277192 B refers to a system to provide real-time access to available funds in at least one medical expenses account, characterized for including: a point of sale system configured to recognize and support real-time transactions which involve at least one medical expenses account, the point of sale system which includes: a first input device with the capacity to recognize items presented for purchase, a second input device with the capacity to recognize a medical expenses account device which identifies at least one medical expenses account, a processing system in communication with the first and second input devices; a transaction processing system which includes: a first data structure configured to contain identifiers of eligible items for items that are eligible for purchase using at least one medical expenses account; a second data structure configured to contain identifiers of authorized items for items authorized for purchase using at least one medical expenses account; a third data structure configured to contain details of transaction data; a decision system which uses the eligible item identifiers contained in the first data structure, the authorized item identifiers contained in the second data structure, and the transaction data details contained in the third data structure to process transactions and provide transaction information to the point of sale system, a first data communications network which connects the point of sale system and the transaction processing system to a financial card network; and a second data communication network which connects the point of sale system and the transaction processing system.

Another technology, registered with the number MX 271530 B provides a money transfer technique, where a financial institution has a network-based server to use it in the money transfer between a client and a beneficiary. The server provides an on-line money transfer service through Internet and the PSTN (Public Switched Telephone Network). A client, who has a client computer, a telephone with access to DTMF (dual-Tone Multi-Frequency) and a credit card, opens a transaction web page provided by the server. The client introduces transaction data in the web page, which includes the amount of money, the information of the client and the beneficiary and the basic payment data, such as the credit card information, except for the credit card number. The client sends the transaction data to the server through Internet. After the client confirms the transaction data in a second web page, the server instructs the client to make contact with the financial institution through the client's telephone. Upon the receipt of the client's telephone call, the server looks for a match between the received ANI (automatic number identification) signal and the telephone number provided by the client. Then the client dials the credit card number, and in return he/she receives a fund collection number (“folio”) in an audible message. The client provides the beneficiary the fund collection number for its use it in the collection of funds.

### BRIEF DESCRIPTION OF THE FIGURES

FIG. 1. Shows the system (1) of authorization of simple, sequential and parallel requests with quick response codes through previously defined parameters, which are the subject of this invention, where the three modules (2)(3)(4) it includes can be observed, as well as its system flow.

FIG. 2. Illustrates the authorization module (2) of the system where all its units are shown.

FIG. 3. Illustrates the request typography module (3) of the system where all its units are shown.

FIG. 4. Illustrates the parameter definition module (4) of the system where all its units are shown.

FIG. 5. Shows a flow diagram with the method of authorization of simple, sequential and parallel requests with means of authorization through previously defined parameters, which are the subject of this invention, where its phases are detailed.

FIG. 6. Shows a flow diagram with the method of authorization of simple, sequential and parallel requests with means of authorization through previously defined parameters, where the interaction with the system modules can be observed.

FIG. 7. Shows a flow diagram of the method of authorization of simple, sequential and parallel requests through previously defined parameters, which are the subject of this invention, where the flow when an authorization through means of authorization is not required, can be observed.

FIG. 8. Shows a flow diagram of the method of authorization of parallel requests through previously defined parameters, which are the subject of this invention.

FIG. 9. Shows a flow diagram of the method of authorization of simple requests through previously defined parameters, which are the subject of this invention.

FIG. 10. Illustrates a graphic representation of the means of authorization, the primary mean of authorization and the secondary mean of authorization, which interact in the method of this invention.

FIG. 11. Illustrates a graphic representation of the means of authorization, when the primary mean of authorization can interact with more than one secondary mean of authorization.

FIG. 12. Shows a flow diagram of the method of authorization of requests when a request authorization is not required.

### DETAILED DESCRIPTION OF THE INVENTION

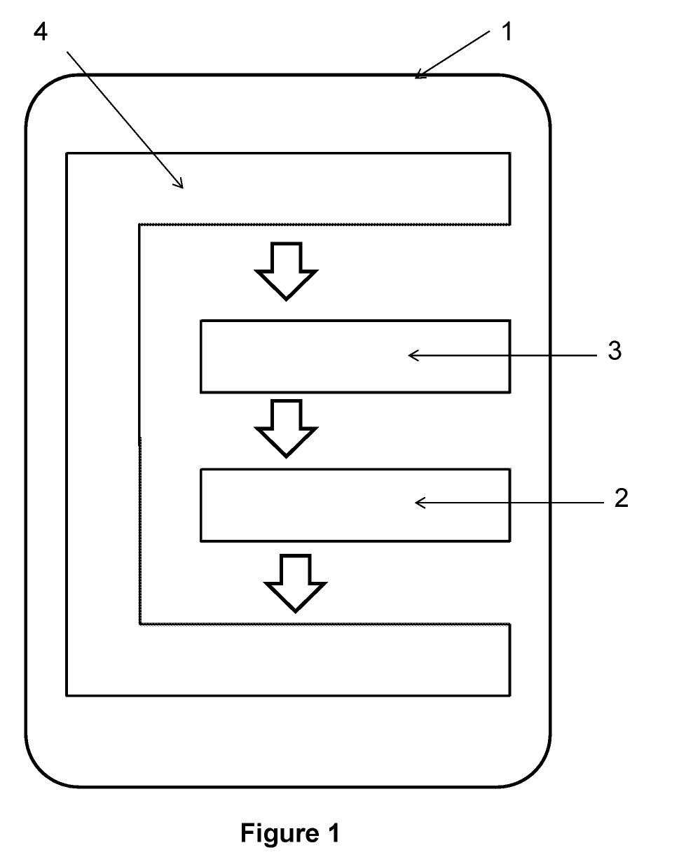

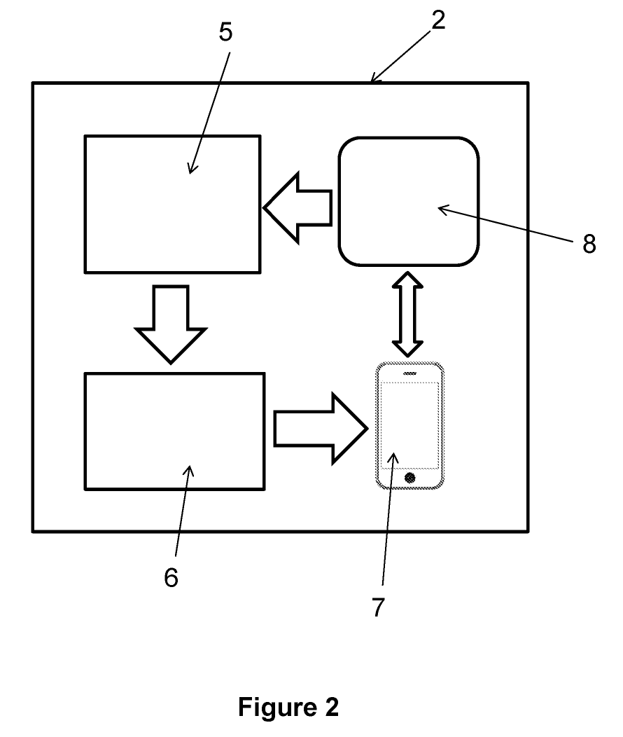

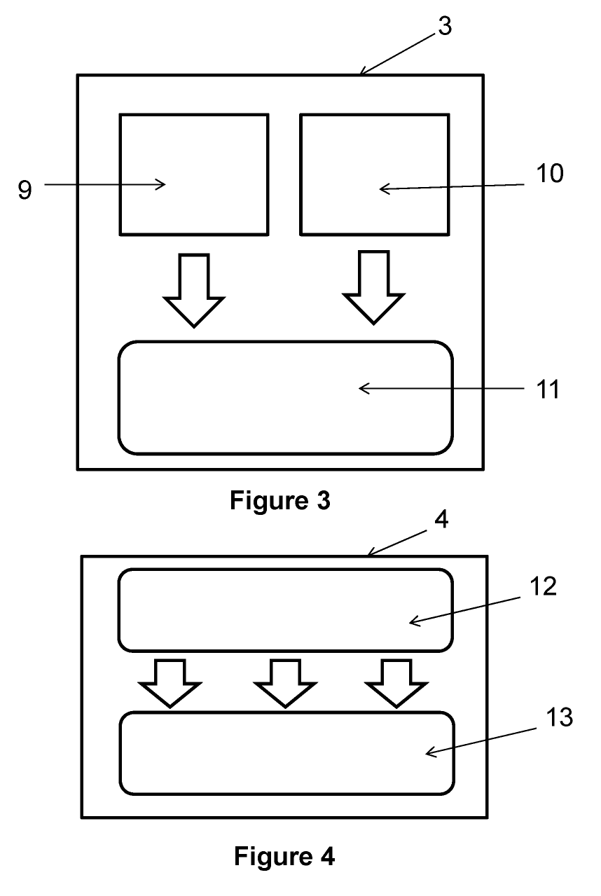

This invention provides a method and a system for the authorization of simple, sequential and parallel requests; such requests are authorized through means of authorization, such means of authorization can be quick response (QR) codes, through previously defined parameters and through manual action; as can be seen in FIG. 1 the system (1) includes a request authorization module through means of authorization (2), a request typography model (3) and a parameter definition module (4); the request authorization module (2) is made up of a request processing unit (5), an encryption unit (6), a mobile device (7) and a request authorization unit (8), as shown in FIG. 2; the request typography module (3), shown in FIG. 3, is made up by a request definition unit (9), a definition unit of groups of request means (10) and a unit for the authorization of requests defined by groups (11); the parameter definition module (4), detailed in FIG. 4, is made up by a rule storage unit (12) and a response definition unit (13).

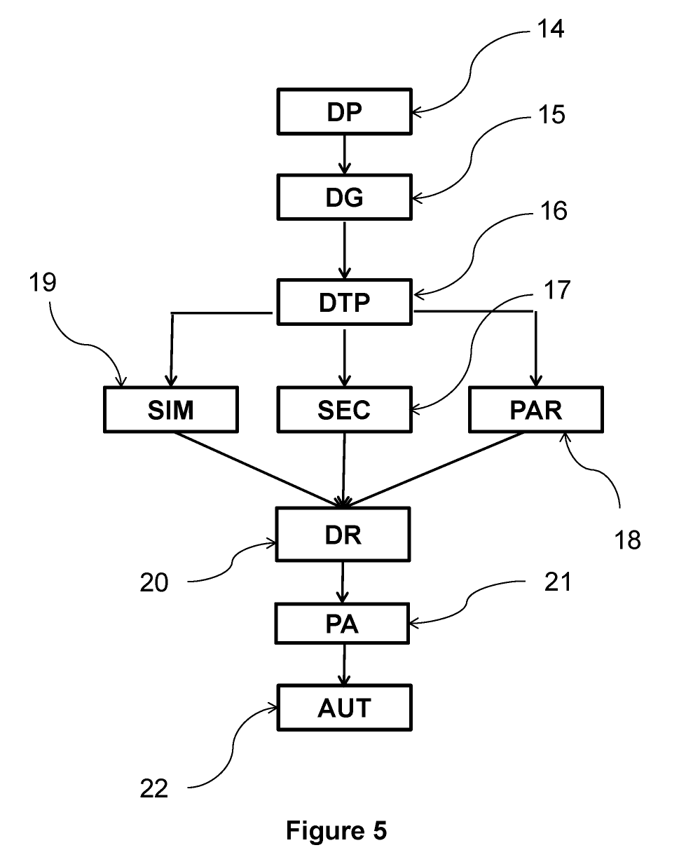

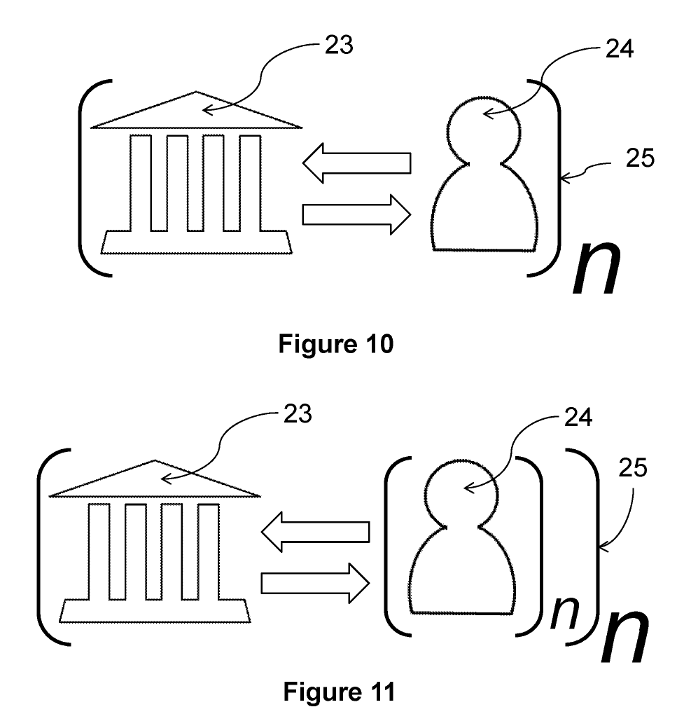

Within the method of authorization of simple, sequential and parallel requests, such requests are authorized through means of authorization through defined parameters, such means are preferably quick response codes (QR), and at least two authorization determination means interact: a primary mean of authorization (23) and a secondary mean of authorization (24) which altogether, act as cells (25) of independent authorization, being able to have an n number of cells (25) interacting with each other, as shown in FIG. 10 where the primary mean of authorization (23) is a service provider, which is chosen from the group that includes financial institutions, lock suppliers, electronic commerce sites, payment processors, service aggregators, institutions which need additional verifications before allowing access to files or transactions and the secondary mean (24) is a client authorizing a request that will be executed through the primary mean of authorization (23), alternatively, the primary mean of authorization (23) can interact with more than one secondary mean of authorization (24), as detailed in FIG. 11, in this specific case, the secondary means of authorization (24) act in a parallel or sequential form; as can be observed in FIG. 5, the method includes the phases of a) Determining (14) DP at least one parameter and one rule for at least one request authorization to obtain a plurality of requests to be executed without authorization and a plurality of requests to be executed with authorization; b) Define groups (15) DG of secondary request means that will execute the plurality of request authorizations to be executed with authorizations obtained in phase a) to obtain at least one type of defined group; c) Stipulate (16) the type of group defined in phase b) which will execute the request authorization to determine the type of authorization; d) Delimit (20) DR the type of request pre-authorization from the authorization determined in phase c) to obtain at least one request mediated by means of authorization; e) Pre-authorization (21) PA of the request mediated by means of authorization delimited in phase d); and f) Authorization (22) AUT of the request with means of authorization, pre-authorized in phase e), which are detailed below:
a) Determine (14) DP at least one parameter and one rule for at least one request authorization to obtain a plurality of requests to be executed without authorization and a plurality of requests to be executed with authorization

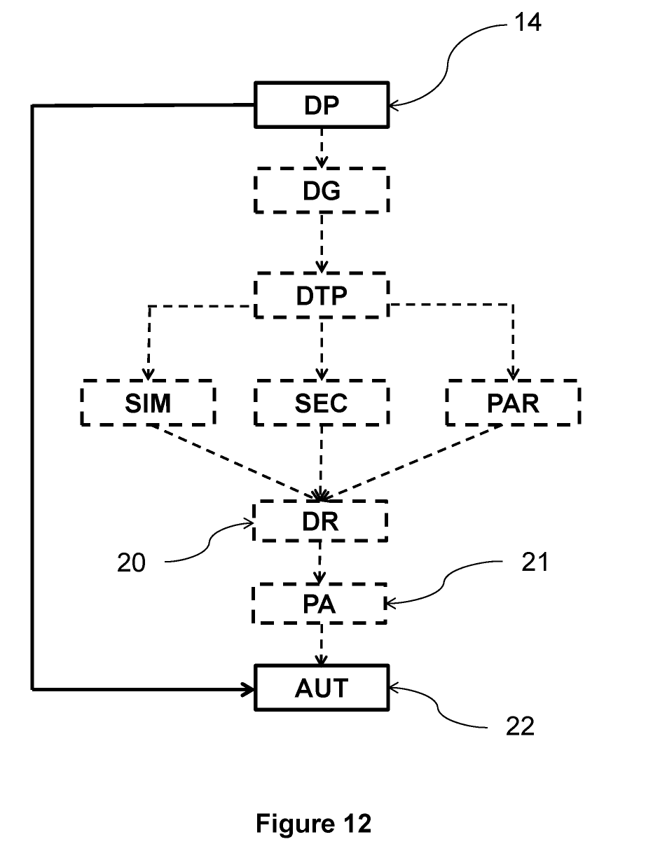

In this phase, the secondary mean defines specific rules which will determine the conditions to authorize requests through the secondary mean, similarly, the secondary mean will establish the parameters to be able to classify the requests automatically in three lists from the beginning of the method: a primary list, which contains the requests to be executed with automatic authorization (white list) based on predefined parameters; a secondary list which includes the requests to be executed with authorization regardless of any restriction but the own authorization, and a tertiary list (black list) which could be defined as a list of restrictive requests, and includes the plurality of requests that will be automatically denied depending on the rules defined in the rule storage unit (12); the requests to be executed with authorization continue through the normal flow of the method which is the subject of this invention, while the requests to be executed without authorization go directly to phase f) Authorization (22) AUT, as shown in FIG. 12, and the requests contained in the restrictive list are not executed; the primary mean of authorization (23) verifies the primary list and the secondary list issued by the secondary mean to determine the requests that will follow in the next phase of the method.
b) Define groups (15) DG of secondary authorization means which will execute the plurality of authorizations of requests to be executed with authorizations obtained in phase a) to obtain at least one type of defined group

At least three types of secondary means of authorization (24) are defined with the capacity of authorizing requests, only the ones located in the list of requests to be executed with authorizations obtained in phase a), similarly, the sequence in which such secondary means of authorization (24) will interact to authorize the request, is defined; the types of groups are: primary group, secondary group and tertiary group.
c) Stipulate (16) the type of group defined in phase b) which will execute the request authorization to determine the type of authorization.

Once the type of group is defined, when a request is executed, the authorization shall be made by all the groups involved independently, being able to follow any of the three following ways:
c.1) Simple request SIM authorization (19)

This type of authorization is executed when there is only one secondary mean group defined; the primary mean of authorization (23) initiates an authorization request to the secondary mean of authorization (24) and the request is executed (if authorized) by primary mean without the need to ask for authorization from another defined group.
c.2) Sequential request SEC authorization (17)

The sequential request authorization is executed when at least two secondary means of authorization (24) originating from at least two defined groups are required to attend an authorization request generated by the primary mean of authorizations (23), which means they are involved in at least i) one secondary mean of authorization (24) of a primary group and at least (ii) one secondary mean of authorization (24) of a secondary group; the primary mean of authorization (23) expects to get a response from all the involved defined groups, using the premise that the first secondary mean of authorization (24) to authorize the request shall belong to a different defined group than the next one to authorize; when last secondary mean of authorization (24) authorizes the request, the primary mean of authorization (23) will execute it. For example, the first one to attend the request is a secondary mean of authorization (24) belonging to the primary group, the next secondary mean of authorization (24) to authorize the request shall belong to a secondary group; if more than two groups are involved, the same premise is used, where the first one to execute the authorization will be a secondary mean of authorization (24) from a primary group, then a secondary mean of authorization (24) of a secondary group and at the end a secondary mean of authorization (24) of a tertiary group; the number of required authorizations for the primary mean of authorization (23) to execute the request will always be equal to the number of involved groups. These premises can be established from phase a).
c.3) Parallel request PAR authorization (18)

The parallel request authorization is executed when at least two secondary means of authorization (24) in different groups receive an authorization request simultaneously and only one authorization is required. The primary mean of authorization (23) generates an authorization request, to execute the such it expects that any of the secondary means of authorization (24), belonging to the groups that received such request, have authorized it. The number of required authorizations for the primary means of authorization (23) to execute such request will always be equals to one (regardless of the number of involved groups). These premises can be established from phase a).
d) Delimit (20) DR the type of request pre-authorization from the authorization determined in phase c) to obtain at least one request mediated by means of authorization

In any of the ways followed in phase c), whether simple authorization, sequential authorization or parallel authorization, the secondary mean of authorization (24) delimits the type of pre-authorization that will be made depending on the security level of the request; such pre-authorization includes requests mediated by means of authorization, which can be quick response (QR) codes, manual and automatic requests; the requests that were manually actioned (approved or denied) and the automatic requests go directly to the phase f) Authorization (22) AUT, those requests mediated by means of authorization go to phase e).
e) Pre-authorization (21) PA of the request mediated by means of authorization delimited in phase d)

The primary mean of authorization (23) generates means of authorization, such means of authorization preferably include quick response (QR) codes, such quick response code has the information of the request previously generated by the primary mean of authorization (23) encrypted, the quick response code includes at least three identification elements: a plurality of characters, a defined numeric value and a plurality of numeric values; the quick response code is deployed through the primary mean of authorization (23), and the secondary mean of authorization (24) acquires it through a reading mean, such reading mean is a mobile device, which generates a code from the three identification elements; the secondary mean of authorization (24) displays such code to the user who has to provide it to the primary mean of authorization (23), for example by typing the code that was displayed by the secondary mean of authorization (24) onto a screen displayed by the primary mean of authorization (23); after the primary mean of authorization (23) receives the code from the user, it will verify the code against the one that it generated, if the code provided by the user and the code generated by the primary mean of authorization (23) match then the request is pre-authorized and it moves to phase f), otherwise it gets denied.
f) Authorization (22) AUT of the request with a quick response code pre-authorized in phase e).

Once the request is pre-authorized, the primary mean of authorization (23) validates the parameters and rules defined in phase a) proceeding to authorize or deny such request; in this phase it is verified if the request was authorized or denied (either by a quick response code—QR—or by a manual action) in Secure Access Mode or if the rule that authorized such request was created while being in Secure Access Mode and then it proceeds to take the defined preventive measure.

Secure Access Mode

In order to carry out any type of authorization within the proposed method, there is a secure access mode, which is optional for the secondary mean of authorization (24), such secure mode is activated and established from the parameter definition module; such secure mode can be activated when any of the users (secondary mean of authorization (24)) of the system is coerced to perform at least one authorization or creation of a rule, in this case, previously, the user generates two password options to enter into the system, a real password and an emergency password, any of which can be a dot matrix to be drawn on the screen of a mobile device, so when the user (secondary mean of authorization (24)) enters into the system to authorize at least one request, he/she will enter the emergency password when he/she is coerced to conduct such authorization and the system will detect it from the parameter definition module for which emergency codes will be generated (which are different to those that are generated in the normal mode); by using the mean of authorization (QR) or by entering into the system, a session will be created with the primary mean of authorization (23) when it is a manual authorization, when this occurs the emergency information goes to the primary mean of authorization (23) who decides what to do with it, being able to cancel the authorization or to inform the authorities or the police forces, depending on the parameters defined in the corresponding module; meanwhile, the secondary mean of authorization (24) (user) is protected since the system is behaving regularly, and being able to emulate a transaction without it really occurring within the system.

Interaction of the Authorization Method with the Modules of the Authorization System

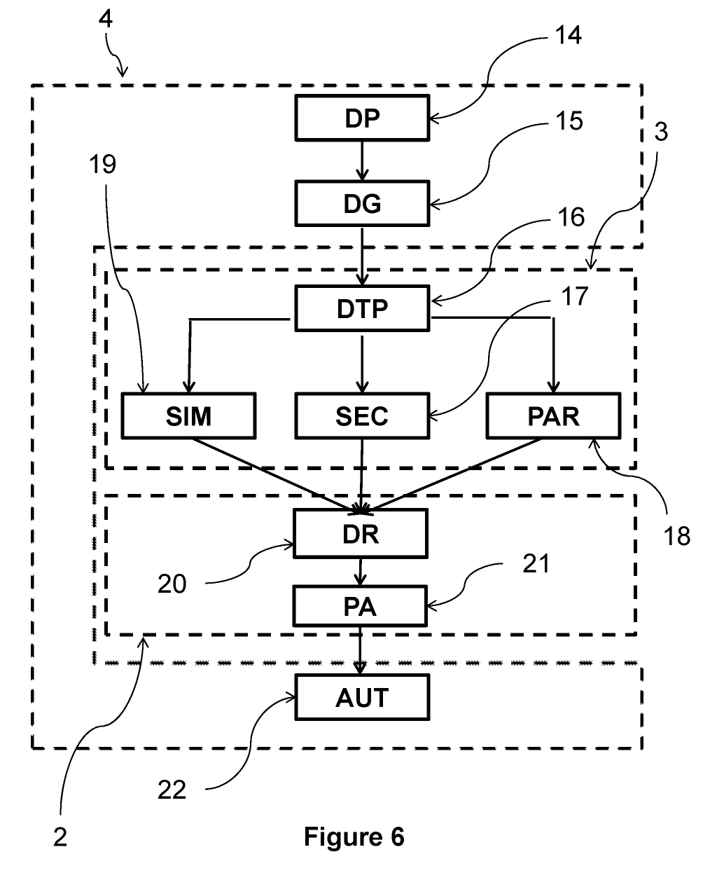

The modules of the system, which are the subject of this invention can be observed in FIG. 1, and the interaction of such modules with the proposed method are observed in FIG. 6, where phase a) Determine (14) DP at least one parameter and one rule for at least one request authorization to obtain a plurality of requests to execute without authorization and a plurality of requests to execute with authorization and phase b) Define groups (15) DG of secondary request means which will execute the plurality of request authorizations to be executed with authorizations obtained in phase a) to obtain at least one type of defined group, occur in the parameter definition module (4) since it includes the rule storage unit (12); such module also intercedes in phase f) Authorization (22) AUT of the request pre-authorized in phase e), since this module (4) includes the response definition unit (13) which will verify the authorization of such phase f). Similarly, phase c) Stipulate (16) the type of group defined in phase b) which will execute the request authorization to determine the type of request typography authorization (3) through its request definition units (9), definition of groups of means of request (10) and of authorization of requests defined by groups (11). And finally, in the module of request authorization (2) the following phases are executed: d) Delimit (20) DR the type of request pre-authorization from an authorization determined in phase c) to obtain at least one request mediated through means of authorization and phase e) Pre-authorization (21) PA of the request mediated by delimited means of authorization in phase d).

### Example 1. Method of Authorization of Sequential Requests Through Previously Defined Parameters when an Authorization from Means of Authorization is not Required

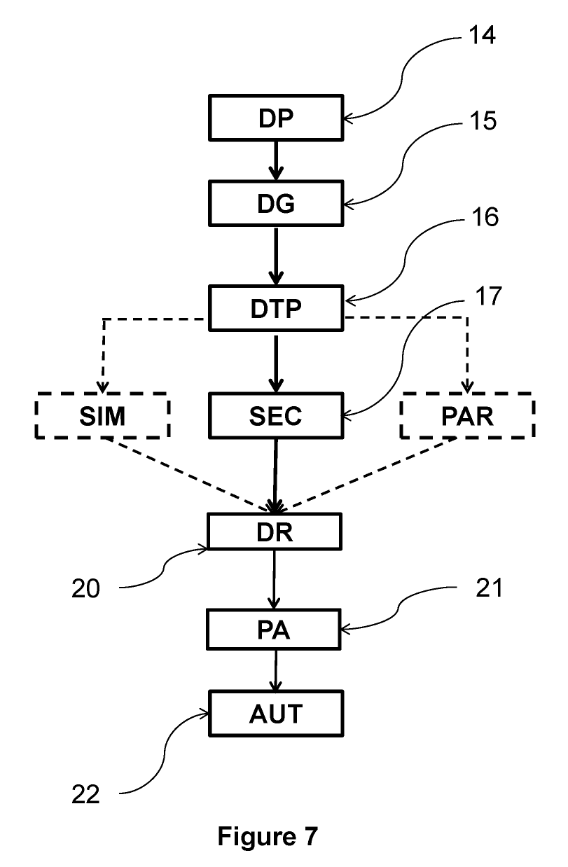

FIG. 7 shows one of the modalities of the invention, where an authorization through a quick code or manual is not required, so the method initiates normally with phase a) Determine (14), then phases b) define (15) and c) Stipulate (16), followed by phase c.2) Authorization (17) SEC of sequential request where the sequential request authorization is executed at least in two secondary means of authorization (24) originating from at least two defined groups are required to handle an authorization request generated by the primary mean of authorization (23), which means that at least i) a secondary mean of authorization (24) of a primary group and at least ii) a secondary mean of authorization (24) of a secondary group; the primary mean of authorization (23) expects to receive a response from all the defined groups that are involved, using the premise that the first secondary mean of authorization (24) to authorize the request shall belong to a different defined group than the next one to authorize; when the last secondary mean of authorization (24) authorizes the request, the primary mean of authorization (23) will execute it. For example, the first one to handle the request is a secondary mean of authorization (24) belonging to a primary group, the next secondary mean of authorization (24) to authorize the request shall belong to a secondary group; in the event more than two groups are involved, the same premise is used, where the first one in executing the authorization will be a secondary mean of authorization (24) of a primary group, then a secondary mean of authorization (24) of a secondary group and at the end a secondary mean of authorization (24) of a tertiary group; the number of authorizations required for the primary mean of authorization (23) to execute such request will always be equal to the number of groups that are involved, for example, when the user (secondary mean of authorization (23)) generates his/her own rules or creates an exclusive rule to conduct the payment of bills and establishes the automatic approval of transfers equal to or less than $500.00 pesos, for example, the direct deposit of a payment; in addition to this rule, which does not require an authorization, it is possible to apply some of the parameters contained in the restrictive list generated in previous phases, being able to put restrictions by transaction schedule or by day of the week or month, so that only the service provider can charge the amount in certain days of the week or month and not through it, avoiding double charges or outside the dates specified.

### Example 2. Method of Authorization of Parallel Requests Through Previously Defined Parameters

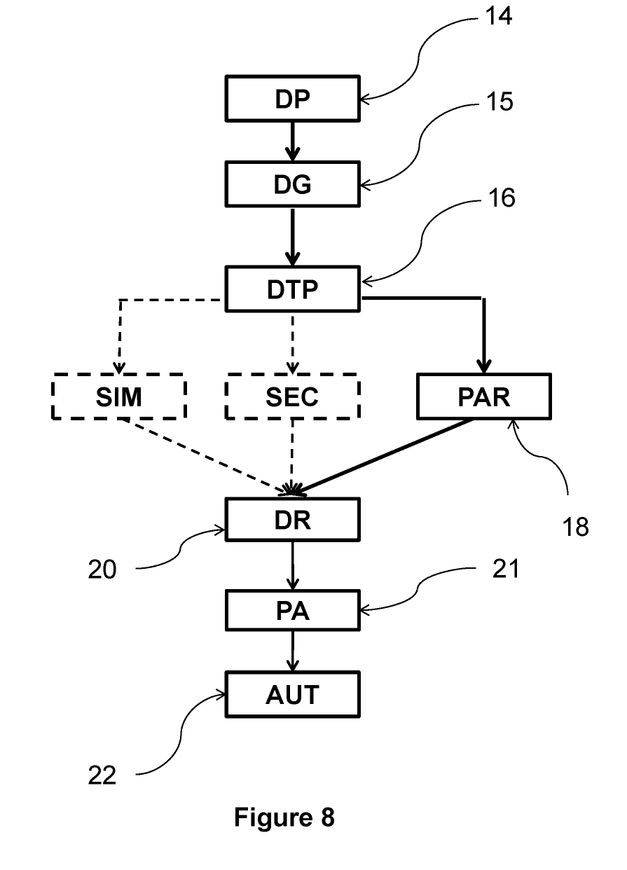

FIG. 8 details one of the modalities of the invention, where the parallel request with quick response codes through previously defined parameters is made, for which the method begins normally with phase a) Determine (14), then the phases b) define (15) and c) Stipulate (16), followed by phase c.3) Authorization (18) PAR of parallel request, which is executed when at least two secondary means of authorization (24) in different groups receive an authorization request simultaneously and only one authorization is required; the primary mean of authorization (23) generates an authorization request, for which to execute it it expects that any of the secondary means of authorization (24), belonging to the groups that received such request, authorizes it; the number of required authorizations for the primary mean of authorization (23) to execute such request will always be equal to one (regardless of the number of involved groups), this can happen for example when a financial transaction in a company needs to be authorized, more specifically a cash withdrawal request of a certain amount ($50,000.00) by one of the departments (purchasing), and such transaction needs to be authorized by one of the supervisors but not all of them, which may or may not be in different departments or hierarchical levels (for example the transaction can be approved by the team leader, the regional manager, and the national manager), but whose authorization is compulsory to conduct the transaction (withdrawal), for which the request of the transaction is made and in order to execute it at the end of the proposed method, the first one of the involved groups that handles the request shall authorize it so it could be sent to the phase f) Authorization (22) AUT of the pre-authorized request in phase e); more specifically it could be said that it applies when the sales managers approve as a secondary group what the sellers are using, but the sales managers are not the only ones who can approve, but also the company's directors can approve the transactions within their own group, so it does not matter which group approves first, whether the sales managers or the directors, any of them can approve the transaction; it should be noted that when the authorization is parallel the means of authorization shall be in separate groups.

### Example 3. Method of Authorization with Quick Response Code Through Previously Defined Parameters

In one of the modalities of the invention, it is possible to conduct a request authorization without using internet, the primary mean of authorization (23) generates means of authorization, in this case a quick response code (QR) and it is displayed by an alternative mean (for example a web page) when a payment authorization is chosen, the system is capable of sending an authorization request alert to the secondary mean of authorization (24) to carry out the transaction, but it is never received because that device in particular does not have internet, so it is not possible to carry out the authorization of the request, since it is required to download its information through the use of the internet, the user can use any other device to access the alternative mean that is being utilized, for example the user can use a computer with internet access to reach the web page utilized by the primary mean of authorization (23) and see the pending payment on the system, here is where an image with the quick response code (QR) is displayed or another type appears, for which a mobile device is used to open the application and read the QR code, and the cell-phone without internet provides a key and is introduced in the system, and if it matches the one generated by the primary mean of authorization (23) for such transaction, it's approved without the need of the internet; if the codes do not match then the primary mean of authorization (23) generates another quick response code (QR) or a different type until the maximum number of attempts is reached, if the maximum number of attempts is reached then the transaction will be automatically cancelled.

### Example 4. Method of Authorization of Simple Requests Through Previously Defined Parameters when a Manual Authorization or Through a Quick Code is not Required

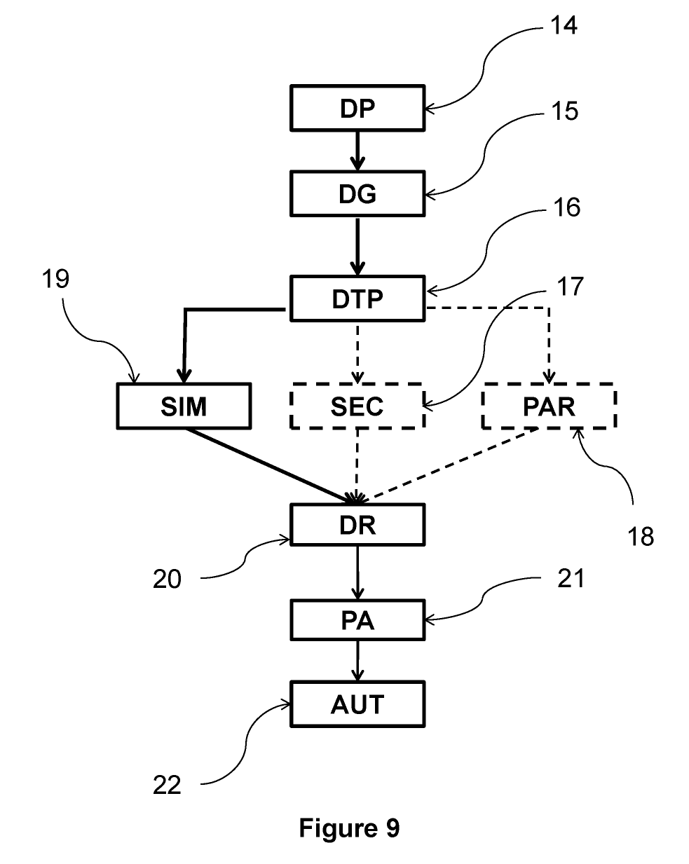

FIG. 9 shows one of the modalities of the invention, where the method of authorization of simple requests through previously defined parameters is conducted when a manual authorization or through a quick code is not required, for which the method initiates normally con phase a) Determine (14), then phases b) define (15) and c) Stipulate (16), followed by phase c.1) Authorization (19) SIM of simple request, which is executed when there is only one defined group of secondary mean, and it can be a primary group; the primary mean of authorization (23) initiates an authorization request to the secondary mean of authorization (24) and the request is executed (if authorized) by the primary mean of authorization (23) without the need to ask for authorization from another defined group, for example certain transactions such as transfers to suppliers, where the range of money to be transferred and the recipient of the transaction have already been established, for which generally these requests are, to some extent, usual within the organization, for which a manual authorization or through a quick code is not required.

Having described sufficiently my invention, which I consider as a novelty and therefore, claim as my exclusive property, what is contained in the following clauses:

1. A System of authorization of simple, sequential and parallel requests with means of authorization through previously defined parameters characterized by including a request authorization module through means of authorization, a request typography module (3) and a parameter definition module (4); the module of authorization (2) of requests is made up by a request processing unit (5), an encryption unit (6), a mobile device (7) and a request authorization unit (8); the request typography module (3) is made up of a request definition unit (9), a unit for the definition of request means groups (10) and a unit for the authorization of requests defined by groups (11); the parameter definition module (4) is made up by a rule storage unit (12) and a response definition unit (13).

2. The system for the authorization of simple, sequential and parallel requests with means of authorization through previously defined parameters, in accordance with claim 1, characterized because such means of authorization are chosen from the group that includes quick response codes (QR), pre-defined rule and manual action.

3. A method of authorization of simple, sequential and parallel requests with means of authorization through previously defined parameters characterized because it includes the phases of
a) Determining (14) DP at least one parameter and one rule for at least one request authorization to obtain a plurality of requests to execute without authorization and a plurality of requests to execute with authorization;
b) Define groups (15) DG of secondary means of authorization which will execute the plurality of request authorizations to be executed with authorizations obtained in phase a) to obtain at least one type of defined group;
c) Stipulate (16) the type of defined group in phase b) which will execute the request authorization to determine the type of authorization;
c.1) Simple request SIM authorization (19);
c.2) Sequential request SEC authorization (17);
c.3) Parallel request PAR authorization (18);
d) Delimit (20) DR the type of request pre-authorization form the authorization determined in phase c) to obtain at least one request mediated by means of authorization;
e) Pre-authorization (21) PA of the request mediated by means of authorization delimited in phase d); and
f) Authorization (22) AUT of the pre-authorized request in phase e).

4. The authorization method of simple, sequential and parallel requests with means of authorization through previously defined parameters, in accordance with claim 3, characterized because in phase a) the secondary mean of authorization defines specific rules which will determine the conditions to authorize requests through the secondary mean of authorization, similarly, the secondary mean of authorization establishes the parameters to classify requests automatically in three lists from the beginning of the method: a primary list, a secondary list and a tertiary list; which includes the requests to be executed with an automatic authorization based on pre-defined parameters; a secondary list which includes the requests to be executed with authorization regardless of any other restriction but the own authorization, and a tertiary or restrictive list, which includes the plurality of requests that will automatically be denied depending on the rules defined in the rule storage unit (12); the primary mean of authorization (23) verifies the primary list and the secondary list issued by the secondary mean to determine the requests that will following in the next phase of the method.

5. The method of authorization of simple, sequential and parallel requests with means of authorization through previously defined parameters, in accordance with claim 4, characterized because the requests to be executed with authorization continue through the normal flow of the method.

6. The method of authorization of simple, sequential and parallel requests with means of authorization through previously defined parameters, in accordance with claim 4, characterized because the requests to execute with automatic authorization go directly to phase f) Authorization (22) AUT.

7. The method of authorization of simple, sequential and parallel requests with means of authorization through previously defined parameters, in accordance with claim 4, characterized because the requests contained in the restrictive list are automatically denied.

8. The method of authorization of simple, sequential and parallel requests with means of authorization through previously defined parameters, in accordance with claim 3, characterized because in phase b) at least three types of secondary means of authorization (24) are defined with the capacity of authorizing requests, only those requests included in the list of requests to execute with authorizations obtained in phase a), similarly, the sequence in which such secondary means of authorization (24) interact to authorize the request, is defined.

9. The method of authorization of simple, sequential and parallel requests with means of authorization through previously defined parameters, in accordance with claim 8, characterized because the types of group are: primary group, secondary group and tertiary group.

10. The method of authorization of simple, sequential and parallel requests with means of authorization through previously defined parameters, in accordance with claim 3, characterized because in phase c) once the type of group is defined, when executing a request, the authorization shall be made by at least one of the groups independently involved, following c.3) Parallel request PAR authorization (18).

11. The method of authorization of simple, sequential and parallel requests with means of authorization through previously defined parameters, in accordance with claim 3, characterized because in phase c) once the type of group is defined, when executing a request, the authorization shall be made by all the groups independently involved, being able to follow any of the three following ways: c.1) Simple request SIM authorization (19) and c.2) Sequential request SEC authorization (17).

12. The method of authorization of simple, sequential and parallel requests with means of authorization through previously defined parameters, in accordance with claim 11, characterized because in phase c.1) it is executed only when there is a defined group of secondary mean, which may be a primary mean; The primary mean of authorization (23) initiates an authorization request to the secondary mean of authorization (24) and the request is executed, if authorized, by the primary mean of authorization (23) without the need to ask for authorization from another defined group.

13. The method of authorization of simple, sequential and parallel requests with means of authorization through previously defined parameters, in accordance with claim 11, characterized because in phase c.2) the sequential request authorization is executed when at least two secondary means of authorization (24) originated from at least two defined groups are required to handle an authorization request generated by the primary mean of authorization (23), which means at least i) one secondary mean of authorization (24) of a primary group and ii) one secondary mean of authorization (24) of a secondary group are involved; the primary mean of authorization (23) expects to receive a response from all the involved pre-defined, using the premise that the first secondary mean of authorization (24) to authorize the request shall belong to a different defined group than the next one to authorize; when the last secondary mean of authorization (24) authorizes the request, the primary mean of authorization (23) will execute it; the required number of authorizations for the primary mean of authorization (23) to execute such request will always be equal to the number of involved groups.

14. The method of authorization of simple, sequential and parallel requests with means of authorization through previously defined parameters, in accordance with claim 13, characterized because the premises can be established from phase a).

15. The method of authorization of simple, sequential and parallel requests with means of authorization through previously defined parameters, in accordance with claim 10, characterized because in phase c.3) the parallel request authorization is executed when at least two secondary means of authorization (24) in different groups receive an authorization request simultaneously and only one is required; the primary mean of authorization (23) generates an authorization request, which in order to execute it waits until any of the secondary means of authorization (24), belonging to the groups that received the request, have authorized it; the required number of authorizations requests for the primary mean of authorization (23) to execute such request will always be equal to one, regardless of the number of involved groups.

16. The method of authorization of simple, sequential and parallel requests with means of authorization through previously defined parameters, in accordance with claim 15, characterized because these premises can be established from phase a).

17. The method of authorization of simple, sequential and parallel requests with means of authorization through previously defined parameters, in accordance with claim 3, characterized because in phase d) in any of the ways followed in phase c), whether simple authorization, sequential authorization or parallel authorization, the secondary mean of authorization (24) delimits the type of pre-authorization which will be conducted depending on the level of security of the request; such pre-authorization includes requests mediated by means of authorization.

18. The method of authorization of simple, sequential and parallel requests with means of authorization through previously defined parameters, in accordance with claim 17, characterized because the means of authorization can be quick response (QR) codes, manual response, and automatic requests.

19. The method of authorization of simple, sequential and parallel requests with means of authorization through previously defined parameters, in accordance with claim 18, characterized because the requests that got a manual response, authorized or denied, and the automatic requests go directly to phase f) Authorization (22) AUT.

20. The method of authorization of simple, sequential and parallel requests with means of authorization through previously defined parameters, in accordance with claim 3, characterized because phase f) the primary mean of authorization (23) validates the parameters and rules defined in the phase a) proceeding to authorize or deny such request; in this phase it is also verified if the request was authorized or denied by a quick response code (QR) or a manual authorization, in Safe Access Mode or if the rule that authorized such request was created while being in Safe Access Mode and then it proceeds to execute the action that was previously defined.

21. The method of authorization of simple, sequential and parallel requests with means of authorization through previously defined parameters, in accordance with claim 18, characterized because those requests mediated by quick response codes (QR) go to phase e).

22. The method of authorization of simple, sequential and parallel requests with means of authorization through previously defined parameters, in accordance with claim 3, characterized because in phase e) the primary mean of authorization (23) generates means of authorization, preferably such means of authorization include quick response (QR) codes; the quick response code is deployed through the primary mean of authorization (23), and the secondary mean of authorization (24) acquires it through a reading mean, which generates a unique key; the secondary mean of authorization (24) displays such code to user and the user has to provide it to the primary mean of authorization (23); after the primary mean of authorization (23) receives the code from the user it verifies it with the code generated by itself, if the code that was provided by the user and the code that was generated by the primary mean of authorization (23) match the request is pre-authorized and moves to the phase f) Authorization AUT (22), otherwise it is denied.

23. The method of authorization of simple, sequential and parallel requests with means of authorization through previously defined parameters, in accordance with claim 22, characterized because the quick response code has the information of the request previously generated by the primary mean of authorization (23) encrypted, such quick response code includes at least three identification methods: a plurality of characters, a defined numeric value and a plurality of numeric values.

24. The method of authorization of simple, sequential and parallel requests with means of authorization through previously defined parameters, in accordance with claim 22, characterized because the reading mean is a mobile device.

25. The method of authorization of simple, sequential and parallel requests with means of authorization through previously defined parameters, in accordance with claim 3, characterized because phase e) is optional since it is only applied when the mean of authorization is a quick response (QR) code.

26. The method of authorization of simple, sequential and parallel requests with means of authorization through previously defined parameters, in accordance with claim 20, characterized because the secure mode is optional for the secondary mean of authorization (24), such secure mode is activated and established from the parameter definition module; it is possible to activate such secure mode when any of the users, secondary means of authorization (24), of the system is coerced to conduct at least one authorization or creation of a rule, in this case, previously, the user generates two password options to enter into the system, a real password and an emergency password, so that when the secondary mean of authorization (24) enters into the system to authorize at least one request, such primary mean of authorization will enter the emergency password when being coerced to conduct such authorization and the system will detect it from the parameter definition module, for which emergency codes will be generated, which is different from the code that would be generated in the normal mode, by using the mean of authorization (QR) or by entering into the system, a session will be created with the primary mean of authorization (23) when it is a manual authorization, when this occurs the emergency information goes to the primary mean of authorization (23) which decides what to do with it, being able to cancel the authorization or to inform the authorities or the police forces, depending on the parameters defined in the corresponding module; meanwhile, the secondary mean of authorization (24) is protected since the system is behaving regularly, being able to emulate a transaction without it really occurring within the system.

27. The method of authorization of simple, sequential and parallel requests with means of authorization through previously defined parameters, in accordance with claim 26, characterized because any of the two passwords can be a dot matrix to be drawn on the screen of a mobile device.
